(19) United States
(12) Patent Application Publication
(10) Pub. No.: US 2008/0014001 A1
(43) Pub. Date: Jan. 17, 2008

(54) Tape printing apparatus and tape printing method

(75) Inventor: Nobuyuki Horii, Tokyo (JP)

Correspondence Address: BACON & THOMAS, PLLC, 625 SLATERS LANE, FOURTH FLOOR, ALEXANDRIA, VA, 22314, US

(73) Assignee: KING JIM CO., LTD., Tokyo (JP)

(21) Appl. No.: 11/812,159

(22) Filed: Jun. 15, 2007

(30) Foreign Application Priority Data
Jul. 14, 2006 (JP) 2006-194396

(51) Int. Cl. B41J 5/30

(52) U.S. Cl. 400/67

(57) ABSTRACT

A tape printing apparatus of the invention includes a character size type storage unit which stores a plurality of types of character sizes; a printable area information storage unit which stores printable area information in a width direction of tape in which a character string is printed; a character size determination unit which determines the character size of each line of an input character string from the character size types based on the number of lines of the input character string and the printable area information of the tape; a character size change instruction operating unit which captures a change instruction of a user for the character size of a line which is specified by the user in the character size of each line determined by the character size determination unit; a character size change process unit which changes the character size of the specified line to a different size in the character size types when the character size change instruction operating unit captures the change instruction of the character size; and a tape printing unit which prints the input character string on the tape with the character size changed by the character size change process unit.

### CROSS-REFERENCE TO RELATED APPLICATION

This application claims, under 35 USC 119, priority of Japanese Application No. 2006-194396 filed Jul. 14, 2006.

### BACKGROUND OF THE INVENTION

1. Field of the Invention

The present invention relates to a tape printing apparatus and a tape printing method, for example, the invention is applied to the tape printing apparatus and tape printing method in which a size of a character string printed on the tape can easily adjusted according to intention of a user.

2. Description of the Related Art

A label producing apparatus is one which produces the cut tape (referred to as label) in which the character string or a picture language is printed, and the label producing apparatus includes a tape printing apparatus which prints the input character string inputted by a user on the tape.

The size of the character string which is printed on the tape by the tape printing apparatus is based on the default character size which is previously determined according to a tape width of a tape cartridge set by a user, and generally the character size can be changed by performing a predetermined operation according to intention of the user. In the case where the character string including at least two lines is printed on the tape, the character size of the character string of each line is automatically adjusted according to the number of input characters of each line or determined using a format in which the character size is determined according to the number of lines.

Japanese Patent Application Laid-Open (JP-A) No. 10-49527 discloses a technique concerning a size change of the input character data. In the technique, inputted character data is stored, and the size of the stored character data is displayed while changed as full size →double size→double height and width size according to an operation time (pressing-down time) of a character key.

JP-A No. 7-125376 discloses a technique of automatically determining a character size attribute of each line when the tape printing apparatus prints lines of the characters including plural lines. In the technique, based on length information on the character string of each line when the character size is set to the same size, the character size attribute of each line is determined such that at least lengths of two lines having longer length information are aligned with each other.

JP-A No. 5-84975 discloses a technique of automatically determining the optimum character size of the print character according to print conditions of the width of the tape which is of a print medium and the number of lines of the inputted characters.

As described above, when the character string including at least two lines is printed on the tape, a tape printing apparatus employs the method in which automatic adjustment is performed according to the number of input characters of each line or the method in which the previously provided format is used to adjust the character size of the character string of each line.

In order to realize the above function, for example, it is necessary that a predetermined operation method be performed using a format setting button on an operation panel.

However, a more simple method capable of determining the character size of the character string of each line is strongly demanded because the predetermined operation method is not always easy for the user.

### SUMMARY OF THE INVENTION

In view of the foregoing, an object of the invention is to provide a tape printing apparatus and a tape printing method in which the character size of the character string of each line can be changed more simply when the character strings including at least two lines are printed on the tape.

A tape printing apparatus according to a first aspect of the invention includes (1) a character size type storage unit which stores a plural types of character sizes; (2) a printable area information storage unit which stores printable area information in a width direction of tape in which a character string is printed; (3) a character size determination unit which determines the character size of each line of an input character string from the character size types based on the number of lines of the input character string and the printable area information of the tape; (4) a character size change instruction operating unit which captures a change instruction of a user for the character size of a line which is specified by the user in the character size of each line determined by the character size determination unit; (5) a character size change process unit which changes the character size of the specified line to a different size in the character size types when the character size change instruction operating unit captures the change instruction of the character size; and (6) a tape printing unit which prints the input character string on the tape with the character size changed by the character size change process unit.

A tape printing method according to a second aspect of the invention has (1) a character size type storage unit which stores plural types of character sizes and (2) a printable area information storage unit which stores printable area information in a width direction of tape in which a character string is printed. The tape printing method includes the steps of (3) determining the character size of each line of an input character string from the character size types using a character size determination unit based on the number of lines of the input character string and the printable area information of the tape; (4) capturing a change instruction of a user using a character size change instruction operating unit for the character size of a line which is specified by the user in the character size of each line determined by the character size determination unit; (5) changing the character size of the specified line to a different size in the character size types using a character size change process unit when the character size change instruction operating unit captures the change instruction of the character size; and (6) printing the input character string on the tape using tape printing unit with the character size changed by the character size change process unit.

### BRIEF DESCRIPTION OF THE DRAWINGS

FIG. 1 is an electric block diagram showing an entire configuration of a tape printing apparatus according to a first embodiment of the invention;

FIG. 2 is a perspective view showing an appearance of the tape printing apparatus of the first embodiment;

FIG. 3 is a view explaining character size data of the first embodiment;

FIG. 4 is a view explaining maximum printable area data of tape of the first embodiment;

FIG. 5 is a flowchart showing a process for determining a character size of at least two-line input character strings of the first embodiment;

FIG. 6 is a flowchart showing a character size change process for enlarging the character size of the first embodiment;

FIGS. 7A to 7E are views explaining a first example of a change image when the character size of the first embodiment is enlarged;

FIGS. 8A to 8D are views explaining a second example of a change image when the character size of the first embodiment is enlarged;

FIG. 9 is a flowchart showing a character size change process for reducing the character size of the first embodiment;

FIGS. 10A to 10F are views explaining a change image when the character size of the first embodiment is reduced;

FIG. 11 is a view showing a display image on a liquid crystal display of the first embodiment;

FIG. 12 is a flowchart showing the character size change process for reducing the character size of a modification of the first embodiment;

FIGS. 13A and 13B are views explaining a first example of the change image when the character size of the modification of the first embodiment is reduced;

FIGS. 14A to 14C are views explaining a second example of the change image when the character size of the modification of the first embodiment is reduced; and

FIGS. 15A and 15B are views explaining a third example of the change image when the character size of the modification of the first embodiment is reduced.

### DESCRIPTION OF THE PREFERRED EMBODIMENTS

### (A) First Embodiment

A first embodiment of a tape printing apparatus and a tape printing method according to the invention will be described in detail below with reference to the drawings.

The first embodiment describes that the tape printing apparatus and the tape printing method according to the invention are applied to a tape printing apparatus included in a label producing apparatus which is of a single dedicated apparatus.

### (A-1) Configuration of First Embodiment

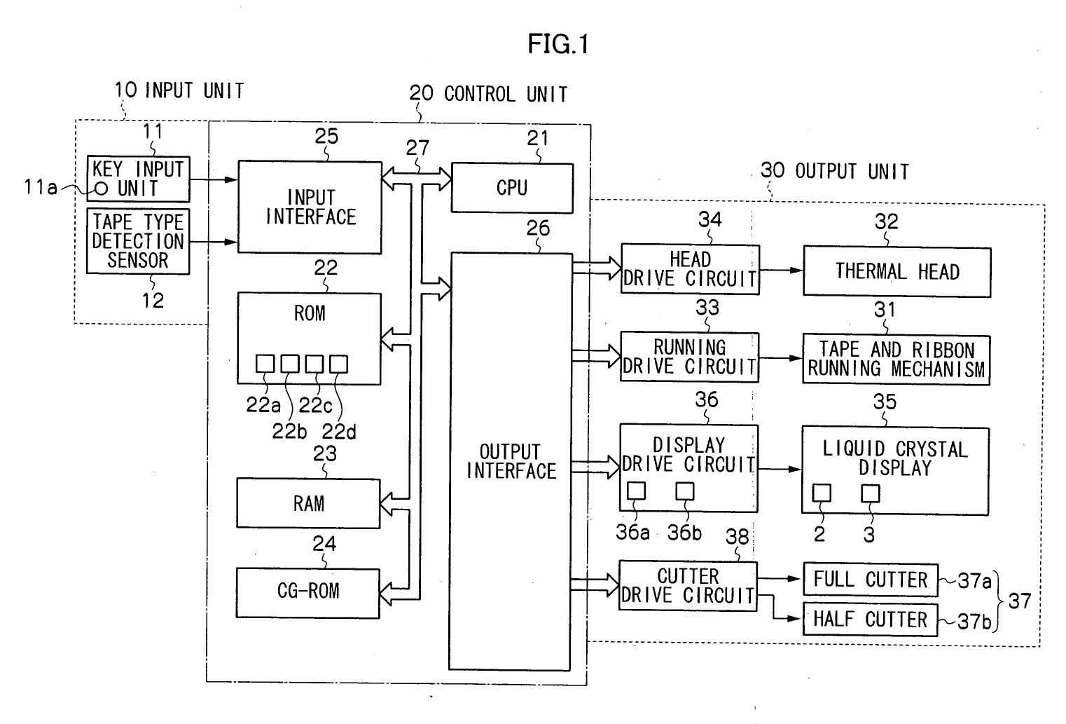

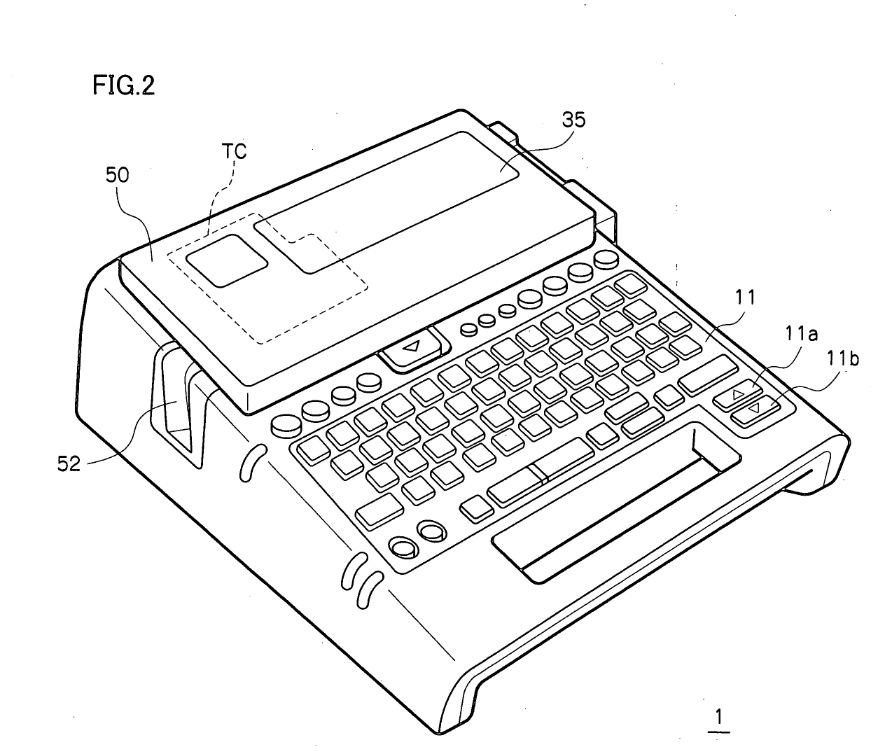

FIG. 1 is an electric block diagram showing an entire configuration of a tape printing apparatus of the first embodiment, and FIG. 2 is a perspective view schematically showing an appearance of the tape printing apparatus.

Referring to FIG. 1, the tape printing apparatus of the first embodiment mainly includes an input unit 10, a control unit 20, and an output unit 30. The control unit 20 performs a process according to information inputted from the input unit 10 or a process stage at that time, and the output unit 30 outputs process result in the form of the display output or print output.

Although the detailed configuration is not described, the input unit 10 includes a key input unit 11 provided with a pressing-down key (or touch panel) and a tape type detection sensor 12. The key input unit 11 generates character codes or various kinds of control data, which are imparted to the control unit 20.

In the configuration of the key input unit 11 shown in FIG. 2, the key input unit 11 has character input keys and various control keys, and the key input unit 11 also has character size change keys 11a and 11b in the first embodiment. The character size change keys 11a and 11b are operation keys for providing an instruction to enlarge or reduce the character size of the character string of the line where the cursor is located. As shown in FIG. 2, the character size change keys 11a and 11b include two kinds of buttons of a character size enlarging button 11a which enlarges the character size of the line and a character size reducing button 11b which reduces the character size of the line. Thus, the character size change key including the character size enlarging button 11a and the character size reducing button 11b is provided, which allows a user to change the character size by the simpler operation without performing the complicated operation of the character size change. Although an arrangement position of the character size change key is not particularly limited, desirably the character size change key is located at the position where the user can perform the operation with the intention of the character size change, and FIG. 2 shows the case in which the character size change key is arranged in a lower right portion of the operation panel.

The tape type detection sensor 12 detects a width and a color (including transparency) of the loaded tape to impart tape type information to the control unit 20. In the method of detecting the tape type with the tape type detection sensor 12, a physical identification factor formed by a hole or the like for defining the tape width or color is provided in a tape cartridge TC loaded in the tape printing apparatus, and the tape type detection sensor 12 reads the physical identification factor to detect the tape type information.

In FIG. 2, a cover 50 having a transparent window is provided above a space in an apparatus housing in which the tape cartridge TC is accommodated. The tape cartridge TC is loaded below the cover 50, and the tape type detection sensor 12 reads the physical identification factor of the tape cartridge TC which is in the loaded state.

The output unit 30 includes a print configuration and a display configuration. As used herein, the print configuration is a configuration which performs the print to the tape, and the display configuration is a configuration which displays the input information printed on the tape or an operation guidance message.

In the print configuration, for example, a print head (in FIG. 1, it is assumed that the print head is formed by a thermal head) 32 is fixed to perform the print to the running tape by thermal transfer. A tape and ribbon running mechanism 31 is mainly formed by a stepping motor or a direct-current motor, and the tape and ribbon running mechanism 31 delivers the loaded tape or ink ribbon (not shown) to a predetermined print position or the outside of the apparatus. The thermal head 32 and the tape and ribbon running mechanism 31 are driven by a head drive circuit 34 and a running drive circuit (including a motor) 33 under the control of the control unit 20 respectively.

A cutter 37 which is driven by a cutter drive circuit (including a motor) 38 cuts the printed tape under the control of the control unit 20. The cutter 37 includes a full cutter 37a and a half cutter 37b. The full cutter 37a cuts both a front cover and a backing sheet in a full cutting mode, and the half cutter 37b cuts only the front cover without cutting the backing sheet in a half cutting mode. In FIG. 2, a discharge port 52 is used to discharge the tape which is being printed therethrough, and the cutter 37 is provided near the discharge port 52.

A liquid crystal display 35 is provided in the display configuration. The liquid crystal display 35 can display several characters (for example, 12 characters) having a predetermined size in several lines (for example, four lines). The liquid crystal display 35 is driven by a display drive circuit 36 under the control of the control unit 20. In the first embodiment, the liquid crystal display 35 is provided on the cover 50 of FIG. 2.

The liquid crystal display 35 includes a dot display unit 2 and an attribute indicator unit 3 (3-1 to 3-n). The dot display unit 2 displays the input character string, a line number, a print image, and length information. Therefore, the display drive circuit 36 mainly includes a drive unit 36a corresponding to the dot display unit 2 and a drive unit 36b corresponding to the attribute indicator unit 3.

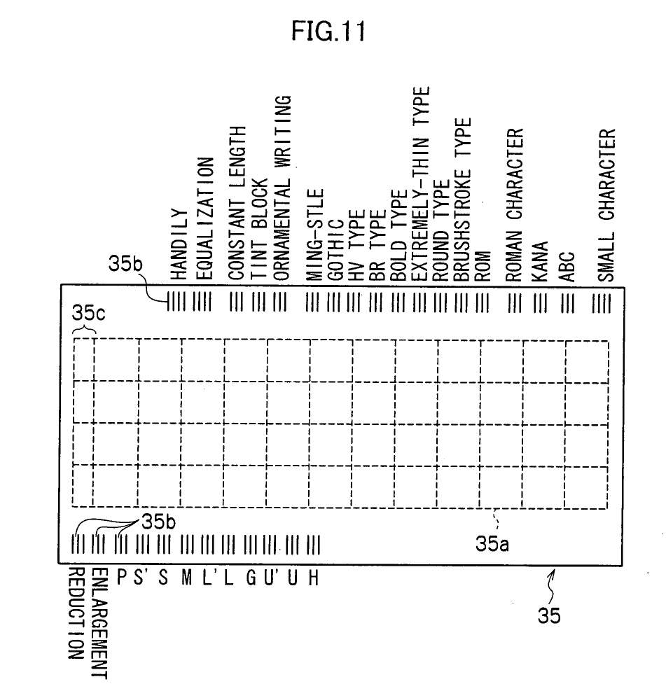

FIG. 11 is a view showing a display screen displayed on the liquid crystal display 35. As shown in FIG. 11, the display screen of the liquid crystal display 35 includes a text display area 35a, an indicator display area 35b, and a line-number display area 35c.

The text display area 35a is one which is used to display the input character string, to display a menu screen in selection input (for example, in changing the character size of the character string of the specified line, in kana-kanji conversion, in code input, and in sign input), and to display various warnings. In the first embodiment, the character string is also displayed in the text display area 35a after the character size of the character string of the specified line is changed for the input character string. FIG. 11 shows the text display area 35a of 12 characters by 4 lines.

The indicator display area 35b is used to display the state of the attribute indicating the character string described in the apparatus body around the liquid crystal display 35. The line-number display area 35c is used to display that the character string displayed on the text display area 35a actually indicates the line number of the input character string.

The control unit 20 is formed by, e.g., a microcomputer. In the control unit 20, a CPU 21, a ROM 22, a RAM 23, a character generator ROM (CG-ROM) 24, an input interface 25, and an output interface 26 are connected to one another through a system bus 27.

The ROM 22 is formed by one or plural ROM chips, and various processing programs and fixed data such as kana-kanji conversion dictionary data are stored in the ROM 22. For example, a character size change program 22a and a character size change program 22b are stored in the ROM 22. The character size change program 22a has a function of enlarging the character size of the specified line when the character size enlarging button 11a is pressed down. On the other hand, the character size change program 22b has a function of reducing the character size of the specified line when the character size reducing button 11b is pressed down.

The RAM 23 is formed by one or plural RAM chips, and the RAM 23 is used as a working memory. Fixed data concerning the user input is also stored in the RAM 23. Although the RAM 23 is described as the RAM 23 in FIG. 1, the RAM 23 is a concept including other memory devices (for example, an EEPROM) used as the working memory. The RAM 23 includes a print buffer, display buffer, a text buffer, a line-number state retaining buffer, and an attribute indicator state retaining buffer. The character string to be printed is stored in the print buffer while dot enlargement is performed to the character string. The display image concerning the input character string is stored in the display buffer. The character data concerning the print and input is stored in the text buffer. The line-number state retaining buffer retains a display mode concerning the line number. The attribute indicator state retaining buffer retains the display mode concerning the attribute indicator 3.

Dot patterns of the characters and signs prepared in the tape printing apparatus are stored in the CG-ROM 24, and the CG-ROM 24 outputs the corresponding dot pattern when code data for specifying the character or sign is imparted. The CG-ROM for display and the CG-ROM for print may individually be provided. A font information storage format may be one of an outline font format and a bitmap format.

The input interface 25 functions as an interface between the input unit 10 and the control unit 20, the output interface 26 functions as an interface between the output unit 30 and the control unit 20.

The CPU 21 processes an input signal transmitted from the input unit 10 and a processing program in the ROM 22, which is determined according to the process stage at that time, while utilizing the RAM 23 as the working area. The CPU 21 also performs process appropriately using the fixed data stored in the ROM 22 or the RAM 23 if needed. The CPU 21 display a process status or process result on the liquid crystal display 35 or prints the process status or process result on the tape.

### (A-2) Operation of First Embodiment

In the tape printing apparatus of the first embodiment, operation of a process of converting the character size of the character string in a certain line in printing the input character strings of several lines on the tape will be described with reference to the drawings.

The operation of the case, in which the user inputs the three-line character string and the size of the character string of a certain line in the three-line character string is changed, will be described by way of example.

### (A-2-1) Automatic Determination Operation of Character Size of Input Character String

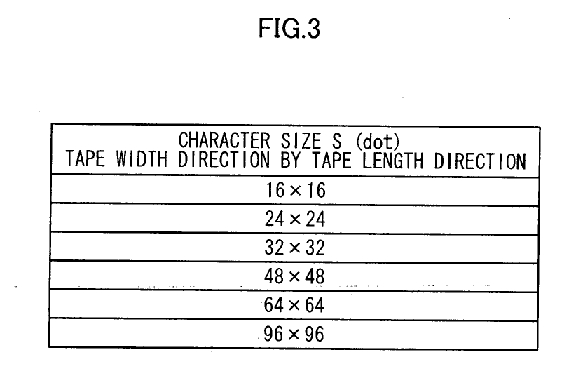

In the tape printing apparatus, character size data 22c of the character printed on the tape is stored in the ROM 22. FIG. 3 shows an example of the character size data 22c. The character size data 22c is formed in the same sizes in the tape width direction and lengthwise direction, and the character size data 22c can be printed on the tape with six types of sizes of 16 by 16 dot, 24 by 24 dot, 32 by 32 dot, 48 by 48 dot, 64 by 64 dot, 96 by 96 dot. In FIG. 3, the character size is set to S, and a unit of the character size is set to dot.

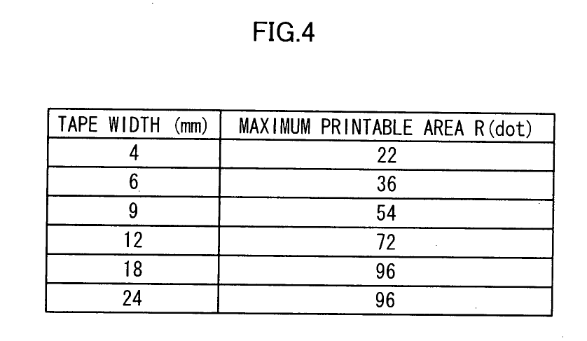

In the tape printing apparatus, maximum printable area data 22d is stored in the ROM 22. The maximum printable area data 22d indicates a printable area in the tape width direction according to the tape width of the loaded tape cartridge TC. FIG. 4 shows an example of the maximum printable area data 22d. In FIG. 4, the maximum print areas are shown for the tapes having the tape widths of 4 mm, 6 mm, 9 mm, 12 mm, 18 mm, and 24 mm. For example, up to 22 dots can be printed in the width direction of the tape having the width of 4 mm. In FIG. 4, the maximum printable area is set to R, and a unit of the maximum printable area is set to dot.

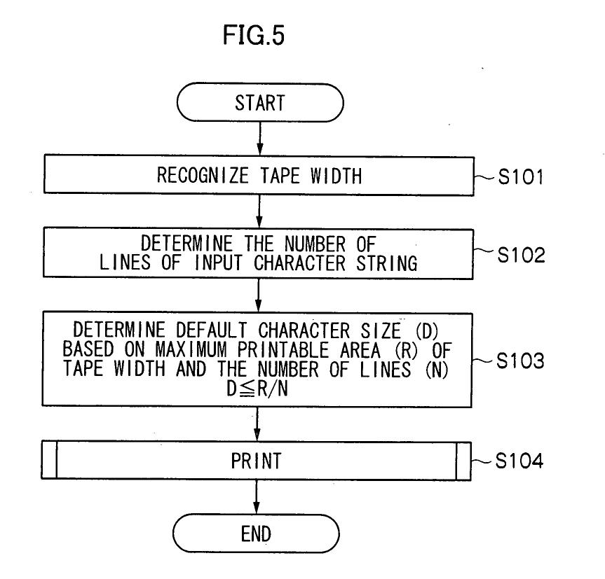

FIG. 5 is a flowchart showing a process for determining the character size of each line when at least two input character strings are printed on the tape.

In the tape printing apparatus, when the user loads the tape cartridge TC, the tape type of the tape cartridge TC is detected to recognize the width of the tape in which the character string is printed (S101).

When the character string inputted by the user operation is captured, a determination is made for the number of lines of the input character string (S102).

Then, the maximum printable area R of the tape is obtained from maximum printable area data 22d stored in the ROM 22, and the character size (default character size, set to D) is determined based on the maximum printable area R and the number of lines (set to N) of the input character string when the size of the character string printed on the tape is equalized (S103).

At this point, the maximum printable area R in the tape width direction is divided by the number of lines N of the character string, and the division result which becomes the maximum in the character size data 22c stored in the ROM 22 is set to the default character size of the character string of each line. That is, the data satisfying the condition of D≦R/N is set to the default character size by referring to the character size data 22c.

In the case where the width of the tape is set to 18 mm, the maximum printable area R in the tape width direction is 96 dots (see FIG. 4). In this case, because maximum printable area R per line/the number of lines in the tape width direction becomes N=96/3=32 when the three-line input character string is printed, the character size of the character string of each line becomes 32 by 32 dot from the character size data 22c (see FIG. 3).

The default character size of the character string of each line may be determined in a millimeter unit or an inch unit.

Thus, the default character size in which the sizes of the character strings of the lines are equalized is determined in the case where the character strings having at least the two lines are inputted. When the user permits the print to be performed with the character size, the character string of each line is printed on the tape with the default character size through a predetermined print operation and print process (S104)

### (A-2-2) Operation of Character Size Enlarging Process

As described above, the character size of the character string of each line is determined in the case where the character string printed on the tape has at least the two lines. The character size of the character string of the line which is desired by the user can be changed as follows.

The process of enlarging the character size of the character string of the line which is desired by the user will be described with reference to the drawings. The case in which the character size of the first-line character string is enlarged in the character strings including the three lines will be described by way of example.

In order to start the character size change process of the first embodiment, after the user inputs at least the two character strings printed on the tape, it is necessary that the user specify the line where the character size is enlarged and press down the character size change key 11a shown in FIG. 1.

Various methods can be applied to the method of specifying the line where the character size is enlarged. In the first embodiment, it is assumed that the line is specified by placing the cursor position to the line in which the change is desired. At this point, the cursor position may be located at any position in the character string as long as the cursor is placed on the line. For example, the cursor may be located at a top of the character string, the cursor may be located in the middle of the character string, and the cursor may be located at an end of the character string. In the first embodiment, as long as the cursor position is placed on the line, it is not necessary to specify a range of the character string whose character size is changed. A foreign language, a numerical character, and a picture language also become targets in the character size change process of the first embodiment.

When the user specifies the line in which the character size is enlarged, the character size change key 11a is pressed down by the user operation. In this case, because the character size is enlarged, the character size enlarging button 11a shown in FIG. 1 is pressed down. Therefore, the character size enlarging button 11a imparts a character size change instruction signal to the CPU 21 through the input interface 25, and the CPU 21 executes the character size change program 22a, which performs the character size change process of enlarging the character size.

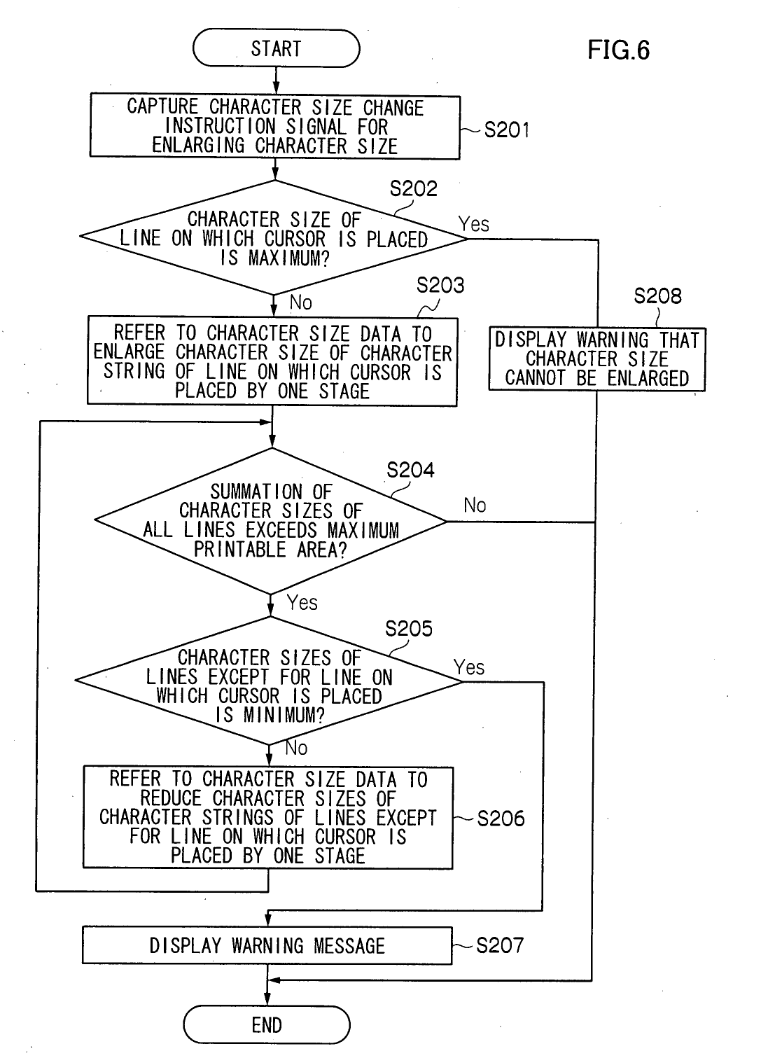

FIG. 6 is a flowchart showing the character size change process for enlarging the character size of the character string in the specified line.

When the character size enlarging button 11a imparts the character size change instruction signal for enlarging the character size (S201), the line on which the cursor is placed is detected, and it is determined whether or not the character size of the character string is a maximum size (S202).

When it is confirmed that the character size of the line is not the maximum size, the character size of the character string of the line on which the cursor is placed is enlarged by one stage by referring to the character size data 22c stored in the ROM 22 (S203).

In S202, because the character sizes of the character strings of all the lines are a default size in the initial action of the character size change instruction, the character size of the line on which the cursor is placed is never the maximum size. Therefore, in the initial action of the character size change instruction, the flow goes to S203. However, when the character size of character string of the line on which the cursor is placed is the maximum size, the flow goes to S208, and the warning that the character size cannot be changed is displayed because the character size of the line of which the character size change is instructed (i.e., the line on which the cursor is placed) is the maximum size (S208).

When the character size of the character string of the line on which the cursor is placed is enlarged by one stage, it is determined whether or not a summation ΣS of the character sizes of all the lines in the tape width direction exceeds the maximum printable area R by referring to the maximum printable area data 22d based on the information on the printable area in the tape width direction, which is stored in the ROM 22 (S204).

When the summation ΣS of the character sizes of all the lines in the tape width direction is not more than the maximum printable area R, the character size change is directly permitted, and the character size of the character string of each line is determined to end the process. That is, the character string of each line is expanded in the state in which the character size is enlarged by one stage for the line on which the cursor is placed while the character size remains at the initial character size for other lines.

On the other hand, when the summation ΣS of the character sizes of all the lines in the tape width direction exceeds the maximum printable area R, it is determined whether or not the character sizes of the character strings of the lines except for the line on which the cursor is placed are a minimum size (S205).

When the character sizes of the character strings of the lines except for the line on which the cursor is placed are not the minimum size, the character sizes of the character strings of the lines except for the line on which the cursor is placed are reduced by one stage by referring to the character size data 22c stored in the ROM 22 (S206). That is, the character size of the character string of the line on which the cursor is placed is enlarged by one stage compare with the initial character size, whereas the character sizes of the character strings of other lines are reduced by one stage compare with the initial character size.

On the other hand, in reducing the character sizes of the character strings of the lines except for the line on which the cursor is placed, when the character sizes of the lines except for the line on which the cursor is placed is the minimum size before the character size change, a predetermined warning message is displayed because the reduction cannot be performed any more (S207).

When the character size change process is performed in the above manner, the character string whose character size is already changed is displayed on the liquid crystal display 35.

When the summation ΣS of the character sizes of all the lines in the tape width direction exceeds the maximum printable area R in S204, the message that the change process cannot be performed is displayed on the liquid crystal display 35, and the user may select continuation or termination of the process. In this method, when the user selects the continuation of the process, the character sizes of the character strings of the lines except for the line on which the cursor is placed is reduced by one stage like the step of S206. On the other hand, when the user selects the termination of the process, the flow returns to the state before the character size change instruction signal for enlarging the character size is imparted, and the process is ended.

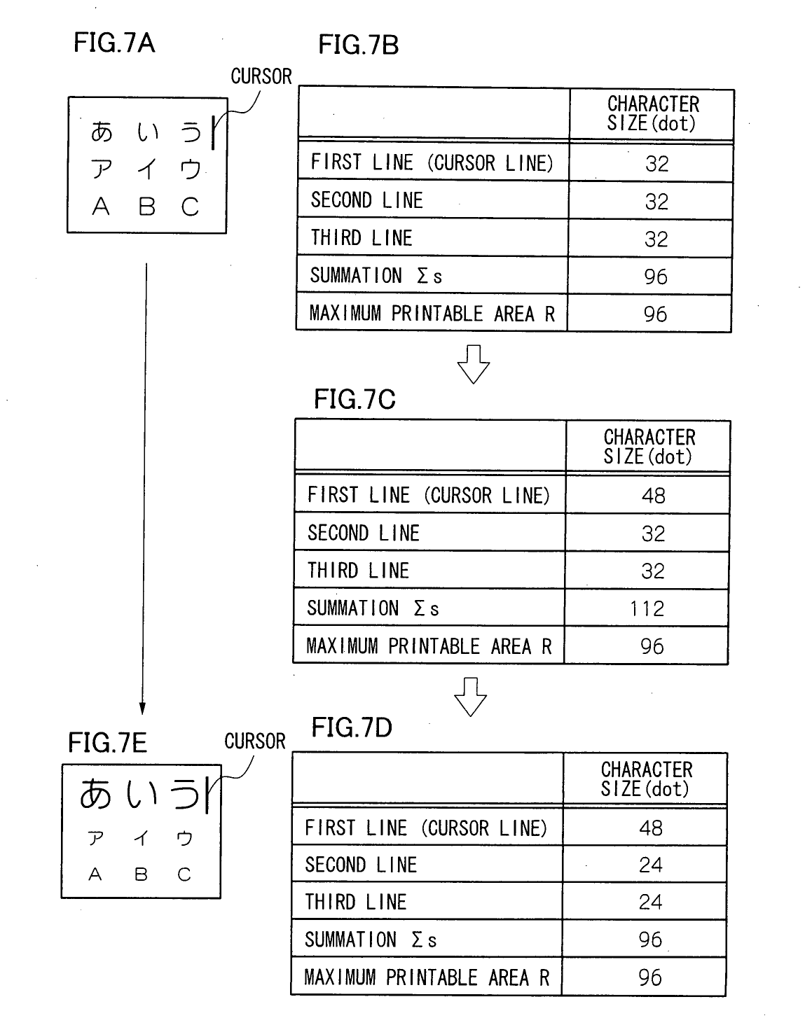

FIGS. 7A to 7E show change images of the three-line input character string printed on the tape having the width of 18 mm. As shown in an example of the liquid crystal display 35 of FIG. 7A, [symbol] is displayed in the first line, [symbol] is displayed in the second line, and “ABC” is displayed in the third line. As shown in FIG. 7B, it is assumed that the character size of each initial line is set to 32 dots.

As shown in FIG. 7A, when the instruction to enlarge the character size is received from the character size enlarging button 11a while the cursor exists in the first line, the character size of the first-line character string is enlarged from 32 dots to 48 dots by one stage as shown in FIG. 7C. Therefore, the summation ΣS of the character sizes of all the lines in the tape width direction becomes 112 dots, and the summation ΣS exceeds the maximum printable area (R=96 dots) of the tape.

Therefore, the character sizes of the lines (i.e., second line and third line) except for the line on which the cursor is placed are reduced by one stage. That is, because the second-line and third-line character sizes are the 32 by 32 dot (see FIG. 7C), the character sizes are reduced to the 24 by 24 dot by one stage as shown in FIG. 7D. This enables the summation ΣS of all the character sizes in the tape width direction to become 96 dots, and the character size change process is ended because the summation ΣS is not more than the maximum printable area (R=96 dots) of the tape.

Thus, the first-line character size is changed to 48 dots while the second-line and third-line character sizes are changed to 24 by 24 dot, the character string of each line is expanded with the changed character sizes, and the character strings are displayed on the liquid crystal display 35 as shown in FIG. 7E.

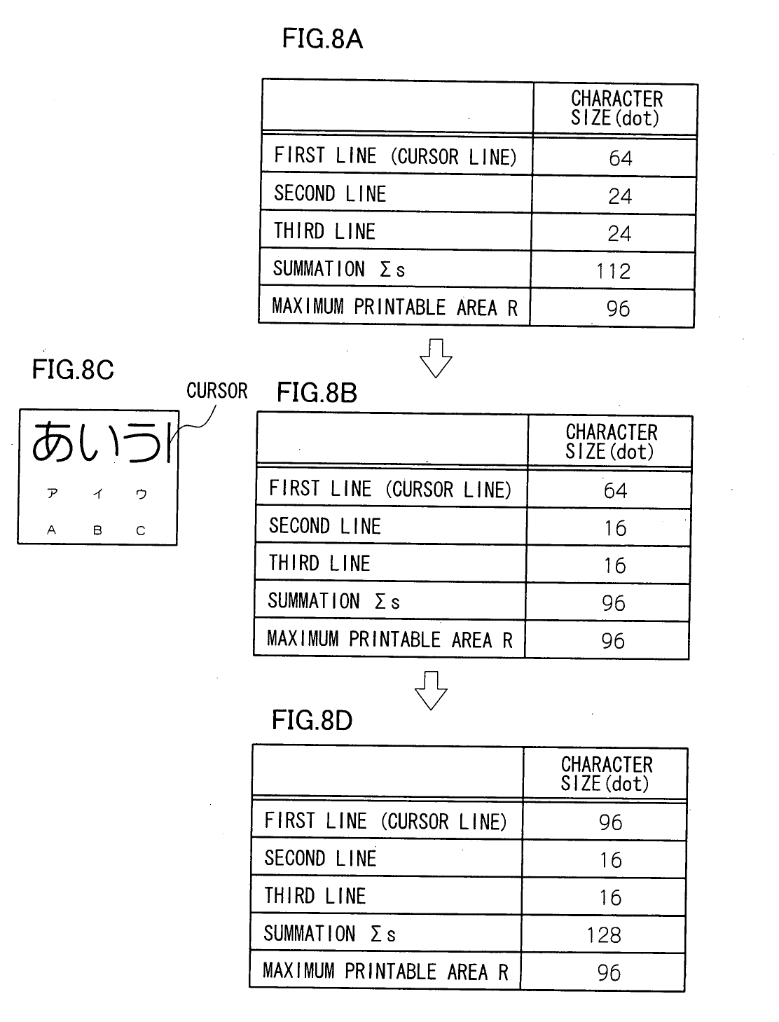

Then, when the user further presses down the character size enlarging button 11a, the character size enlarging instruction signal is received from the character size enlarging button, and the first-line character size is enlarged from the 48 by 48 dot to the 64 by 64 dot by one stage as shown in FIG. 8A.

The summation ΣS of the character sizes of all the lines in the tape width direction becomes 112 dots, because the summation ΣS exceeds the maximum printable area (R=96 dots) of the tape, the character sizes of the lines (i.e., second and third lines) except for the line on which the cursor is placed are reduced by one stage as shown in FIG. 8B. Therefore, as shown in FIG. 8C, the first-line character size is changed to the 64 by 64 dot while the second-line and third-line character sizes are changed to the 16 by 16 dot, and the character string of each line is expanded with the changed character sizes.

Because the character size data 22c stored in the ROM 22 has the minimum size of 16 by 16 dot, even if the user further presses down the character size enlarging button 11a in the states shown in FIGS. 8B and 8C such that the character size enlarging instruction signal is received from the character size enlarging button 11a, the character sizes of the lines (second line and third lines) except for the line on which the cursor is placed cannot be reduced. Therefore, for example, the warning of “character size cannot be reduced any more” is displayed.

### (A-2-3) Operation of Character Size Reducing Process

The process of reducing the character size of the character string of the line which is desired by the user will be described with reference to the drawings. The case in which the character size of the first-line character string is reduced in the character strings including the three lines will be described by way of example.

The line in which the character size is reduced can be specified in the same manner as that of (A-2-2). When the line is specified by the user, the character size reducing button 11b is pressed down by the user operation. Therefore, the character size reducing button 11b imparts the character size change instruction signal to the CPU 21 through the input interface 25, and the CPU 21 executes the character size change program 22b, which performs the character size change process of reducing the character size.

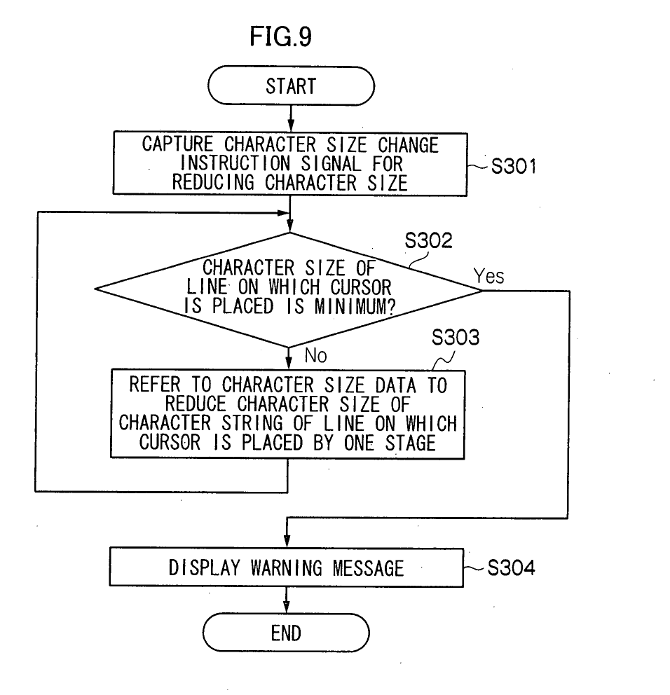

FIG. 9 is a flowchart showing the character size change process for reducing the character size of the character string in the specified line.

When the character size reducing button 11b imparts the character size change instruction signal for reducing the character size (S301), the line on which the cursor is placed is detected, and it is determined whether or not the character size of the character string is a minimum size (S302).

When it is confirmed that the character size of the line is not the minimum size, the character size of the character string of the line on which the cursor is placed is reduced by one stage by referring to the character size data 22c stored in the ROM 22 (S303).

At this point, the character sizes of the character strings of the lines except for the line on which the cursor is placed are not changed. Accordingly, because only the character size of the line on which the cursor is placed is changed, the summation of the character strings of all the lines in the tape width direction always becomes not more than maximum printable area R.

In reducing the character sizes of the character strings of the lines except for the line on which the cursor is placed, when the character size before the change is the minimum size in the character size data 22c, because the character size cannot be reduced any more, a predetermined warning message is displayed (S304). When the character size before the change is not the minimum size, the character size change process is ended while the character sizes of the lines except for the line on which the cursor is placed is reduced by one stage, and the character string of each line is expanded.

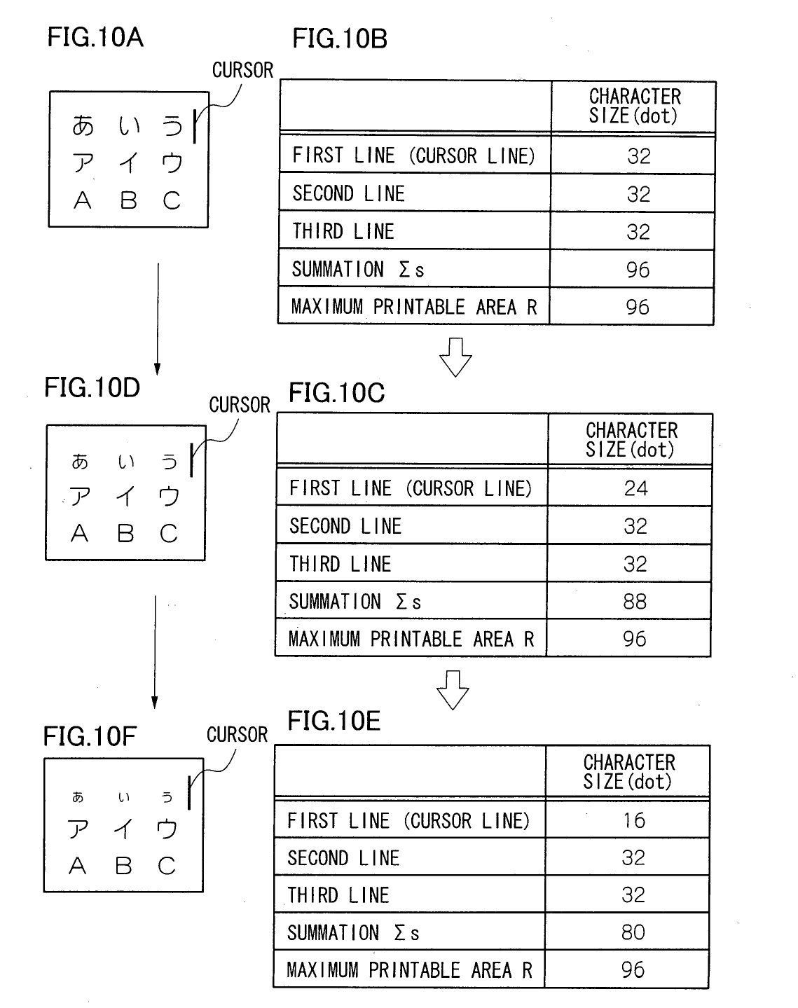

FIGS. 10A to 10F show change images of the three-line input character string printed on the tape having the width of 18 mm. As shown in an example of the liquid crystal display 35 of FIG. 10A, [symbol] is displayed in the first line, [symbol] is displayed in the second line, and “ABC” is displayed in the third line. As shown in FIG. 10B, it is assumed that the character size of each initial line is set to 32 dots.

As shown in FIG. FIG. 10A, when the instruction to reduce the character size is received from the character size reducing button 11b while the cursor exists in the first line, the character size of the first-line character string is reduced from the 32 by 32 dot to the 24 by 24 dot by one stage as shown in FIG. 10C. Therefore, the summation ΣS of the character sizes of all the lines in the tape width direction becomes 88 dots, and the summation ΣS is not more than the maximum printable area (R=96 dots) of the tape because the character sizes of the second-line and third-line character strings are not changed.

Therefore, the first-line character size is changed to the 24 by 24 dot while the second-line and third-line character sizes are maintained at the 32 by 32 dot, the character string of each line is expanded with the character sizes, and the character strings are displayed on the liquid crystal display 35 as shown in FIG. 10D.

Then, when the user further presses down the character size reducing button 11b, the instruction to further reduce the character size is received from the character size reducing button 11b, and the first-line character size is further reduced from 24 dots to 16 dots by one stage as shown in FIG. 10E. Because the character sizes of the second-line and third-line character strings are not changed, the summation ΣS of the character sizes of all the lines in the tape width direction becomes 80 dots, and the summation ΣS is not more than the maximum printable area (R=96 dots) of the tape.

Therefore, the first-line character size is changed to the 16 by 16 dot while the second-line and third-line character sizes are maintained at the 32 by 32 dot, the character string of each line is expanded with the character sizes, and the character strings are displayed on the liquid crystal display 35 as shown in FIG. 10F.

Because the character size data 22c stored in the ROM 22 has the minimum size of 16 by 16 dot, even if the user further presses down the character size reducing button 11b in the states shown in FIGS. 10E and 10F such that the instruction to reduce the character size is received from the character size reducing button 11b, for example, the warning of “character size cannot be reduced any more” is displayed.

Thus, according to the first embodiment, the character size enlarging button 11a and the character size reducing button 11b are provided on the operation panel, so that the character size of the character string of the line in which the character string change is desired can be changed by the operation which is simpler than ever before.

According to the first embodiment, the determination is also made for the relationship between the summation of the character sizes of all the lines in the tape width direction and the maximum printable area of the tape. Therefore, in the case where the total number of character sizes exceeds the maximum printable area of the tape due to the character size change of the line of which the change is instructed, the total number of character sizes can be adjusted so as to stay within the maximum printable area of the tape by also changing the character sizes of the lines except for the line of which the change is instructed.

### (B) Other Embodiments

### (B-1) Operation of Character Size Enlarging Button 11a

A character size change key (not shown) which is of one button for realizing both the functions of the character size enlarging button 11a and character size reducing button 11b may be provided to cause the character size change key to have an auto repeat function. Therefore, when the user continuously presses down the character size change key 11, the character size can be changed like 32 by 32 dot→24 by 24 dot→16 by 16 dot after each predetermined time elapses in the case where the original character size is the 32 by 32 dot. When the character size change key 11 is continuously pressed down after the character size is changed to the minimum size, the character size can be returned character size to the original character size like 16 by 16 dot→32 by 32 by→ . . .

In the above example, the character size may be set to the maximum size after the minimum size. That is, the character size may be changed like 16 by 16 dot →96 by 96 dot→64 by 64 dot→ . . .

“A revival key” may be provided on the operation panel to return the character size of the character string of each line to the initial character size or last character size by pressing down the revival key. In this case, the initial character size of each line and the character size of each line to which the character size change process is already performed are temporarily stored in the storage unit, and the initial character size of each line and the character size of each line to which the character size change process is already performed can be read from the storage unit and displayed on the liquid crystal display by receiving a revival instruction signal from the revival key. A layout of a combination of the character sizes is previously possessed as a table, the character size is called by referring to the table, and thereby the character size may be returned to the initial character size or the last character size.

Thus, the character size change instruction operating unit according to the first aspect of the invention is not limited to the one operation key but includes a concept formed by the plural operation keys.

### (B-2) Character Size Change Process

The character size change process shown by the flowcharts of FIGS. 6 and 9 of the first embodiment is not limited to the process contents shown in FIGS. 6 and 9, but other process contents can be added, the process sequence can be changed, and other contents can widely be applied if needed.

In FIGS. 6 to FIGS. 8A to 8D, when enlarging the character size of the character string of the specified line, the character sizes of all the lines except for the specified line are reduced according to the maximum printable area of the tape. However, the character size of the particular line may be reduced in the lines except for the specified line. At this point, the line in which the character size is reduced may be specified by the user, and there may be plural particular lines in which the character size is reduced. Additionally, the line in which the character size is reduced may be changed to produce plural character size change patterns.

In displaying the result on the liquid crystal display 35 after the character size is changed, the change result obtained by reducing the character sizes of all the lines except for the specified line and the result obtained by reducing the character size of the particular line in the lines except for the specified line are sequentially displayed by a predetermined operation of the user, and the change pattern may be selected from the results according to preference of the user.

In the operation of the first embodiment, only the first-line character size is changed. However, for example, the character sizes of the plural lines can be changed by repeating the same process such that the second-line character size is changed after the first-line character size is changed.

In the case where the tape printing apparatus has the format function of determining the character size of the character strings having at least two lines in the previously set format, a higher priority can be given to one of the format function and the character size change processing function when the user selects both the format function and the character size change processing function of the first embodiment.

That is, from the viewpoint of ensuring effectiveness of the format function having the feature that a layout can easily be performed by setting contents, the performance of the character size change processing function of the first embodiment may be eliminated when the format function is selected. A higher priority may be given to the performance of the format function when the format function is selected after the character size is adjusted by the character size change processing function of the first embodiment.

On the contrary, when the character size change process of the first embodiment is selected after the format function is selected, a higher priority may be given to the performance of the character size change process of the first embodiment to end the process performed by the format function.

The character size change process of the first embodiment may be modified as follows. The character size of a certain line can be fixed, and the character size change process of the first embodiment may be performed to other lines. Therefore, the character size of the line which is desired by the user can be determined and fixed on a priority basis, and then the character sizes of lines except for the line can be adjusted.

In the character size change process of reducing the character size, a process of changing the character sizes of other lines may be performed like the following modification of the first embodiment.

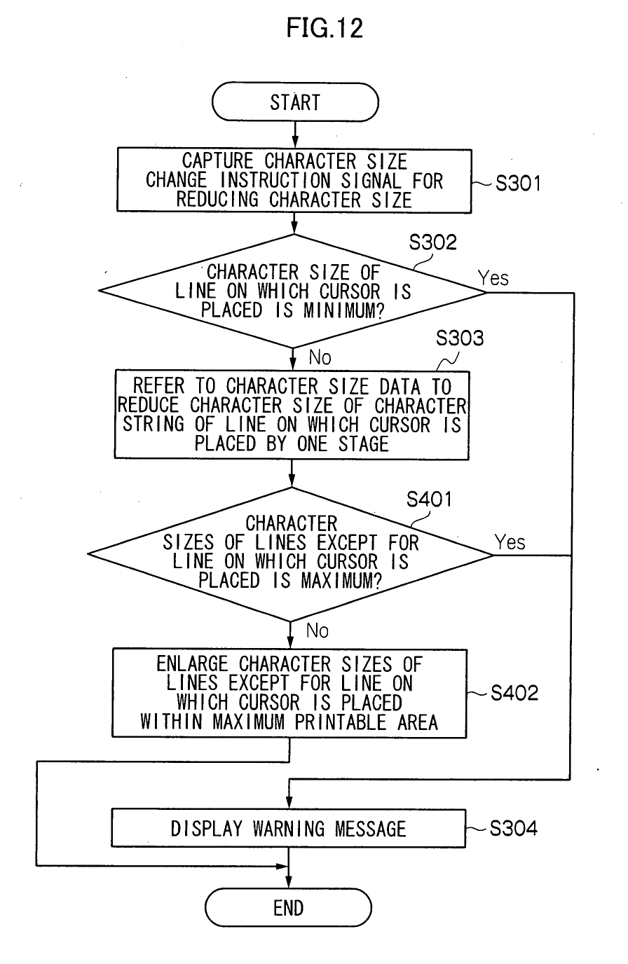

FIG. 12 is a flowchart showing a modification of the first embodiment. As with the flowchart of FIG. 9, when the character size change instruction signal of reducing the character size is captured from the character size reducing button 11b pressed down by the user (S301), it is determined whether or not the character size of the line on which the cursor is located is the minimum (S302). When it is determined that the character size of the line on which the cursor is located is not the minimum, the character size of the character string of the line on which the cursor is located is reduced by one stage (S303).

When the character size of the line on which the cursor is located is reduced by one stage, because the summation ΣS of the character sizes of all the lines in the tape width direction is decreased, the character size of the lines except for the line on which the cursor is located is enlarged in the modification.

That is, when the character size of the line on which the cursor is located is reduced by one stage in S303, the flow goes to S401, and it is determined whether or not the character sizes of the lines except for the line on which the cursor is located are the maximum size (S401). When the character sizes of the lines except for the line on which the cursor is located are not the maximum size, the character size of the character string is enlarged within the maximum printable area by referring to the character size data 22c for the lines except for the line on which the cursor is located (S402).

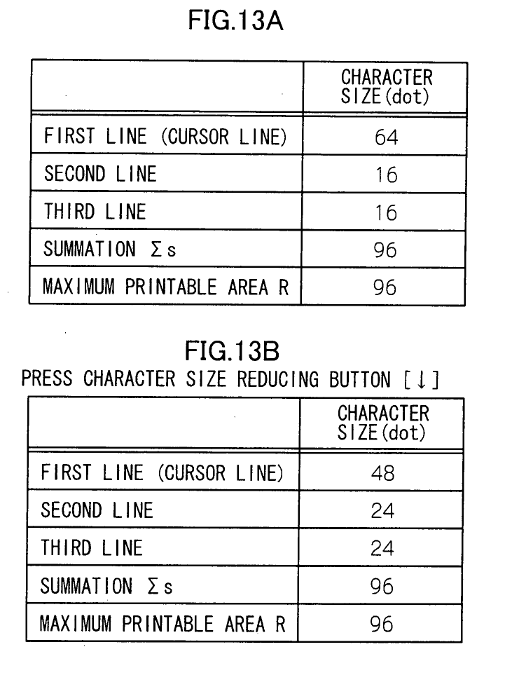

FIGS. 13A and 13B, 14A to 14C, and 15A and 15B show the modifications of the first embodiment. These Figures show change images of the three-line input character string printed on the tape having the width of 18 mm. FIGS. 13A, 14A, and 15A show the character sizes of the lines before the change, the first line has the character size of 64 by 64 dot, the second line has the character size of 16 by 16 dot, and the third line has the character size of 16 by 16 dot.

FIGS. 13A and 13B show examples in which the character sizes of all the lines except for the line on which the cursor is placed are enlarged in accordance with the maximum printable area. That is, after the first-line character size is reduced by one stage, the second-line and third-line character sizes are enlarged as much as possible in accordance with the maximum printable area R (=96 dots).

When the first-line character size is reduced from “64 by 64 dot” to “48 by 48 dot”, the summation ΣS of the character sizes of all the lines in the tape width direction becomes 80 dots. As shown in FIG. 13B, each of the second-line and third-line character sizes is enlarged from “16 by 16 dot” to “24 by 24 dot” so as to be enlarged as much as possible for the maximum printable area R (=96 dots).

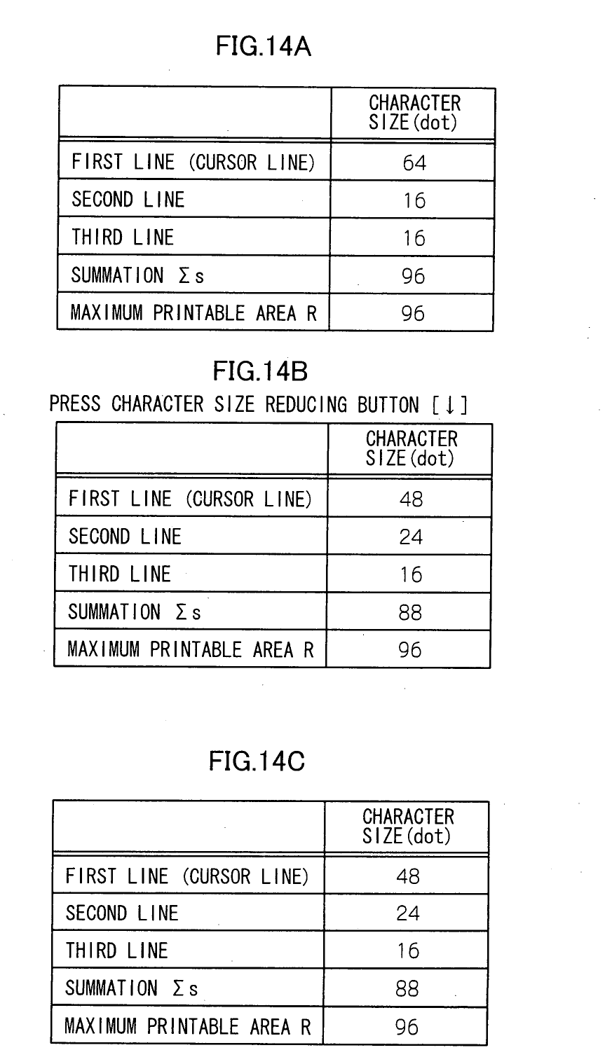

FIGS. 14A to 14C show examples in which the character size of the particular line in the lines except for the line on which the cursor is placed is enlarged. That is, after the first-line character size is reduced by one stage, the character size of the particular line in the second and third lines is enlarged.

When the first-line character size is reduced from “64 by 64 dot” to “48 by 48 dot”, the character size of one of the second and third lines is enlarged from “16 by 16 dot” to “24 by 24 dot”, as shown in FIG. 14B or 14C.

At least two lines may be set to the line in which the character size is enlarged, and the specification of the line in which the character size is enlarged may be determined by the user.

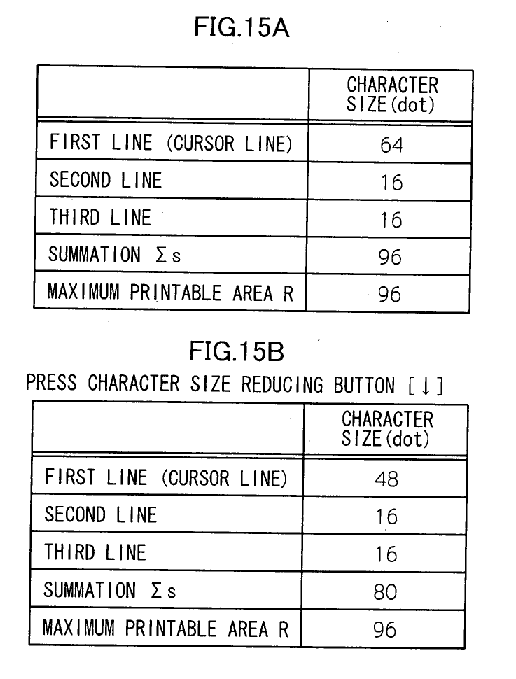

FIGS. 15A and 15B show examples in which the character sizes of the lines except for the line on which the cursor is placed are not changed. In this case, the flowchart of FIG. 9 is applied, so that the detailed description is not repeated.

The examples of FIGS. 13A and 13B, 14A to 14C, and 15A and 15B may be realized as the single process, and the examples maybe combined. That is, the change result of FIG. 13B, the change result of FIG. 14B, the change result of FIG. 14C, and the change result of FIG. 15B are sequentially displayed on the liquid crystal display 35 by a predetermined operation of the user, and the change result may be selected from these change results by the user operation.

When the character size of a certain line is reduced, because the summation ΣS of the character sizes of all the lines in the tape width direction is decreased, a line space is increased to generate an undesirable margin in printing the characters on the tape. However, in the modification, the character sizes of other lines can be enlarged within the maximum printable area R of the tape, so that the generation of the undesirable margin can be prevented. Additionally, the change pattern can be selected from the plural character size change patterns according to preference of the user.

### (B-3) Others

Although the invention is applied to the tape printing apparatus for producing the label which is of the single dedicated apparatus in the first embodiment, the invention is not limited to the first embodiment. For example, the tape printing program according to the invention is stored in a recording medium (for example, the CD-ROM), a hard disk, and the like, and the invention may be realized by executing the tape printing program of the invention with a personal computer connected to a label printer. In this case, the line in which the character size is changed may be specified by a mouse and the like.

What is claimed is:

1. A tape printing apparatus comprising:
a character size type storage unit which stores a plurality of types of character sizes;
a printable area information storage unit which stores printable area information in a width direction of a tape in which a character string is printed;
a character size determination unit which determines the character size of each line of an input character string from the character size types based on the number of lines of the input character string and the printable area information of the tape;
a character size change instruction operating unit which captures a change instruction of a user for the character size of a line which is specified by the user in the character size of each line determined by the character size determination unit;
a character size change process unit which changes the character size of the specified line to a different size in the character size types when the character size change instruction operating unit captures the change instruction of the character size; and
a tape printing unit which prints the input character string on the tape with the character size changed by the character size change process unit.

2. The tape printing apparatus according to claim 1, wherein it is determined whether or not a summation of the character sizes of all the lines of the input character string in the tape width direction exceeds the printable area information in the tape width direction after the character size change process unit changes the character size of the specified line, and the character size of a line except for the specified line is also changed when the summation of the character sizes of all the lines of the input character string in the tape width direction is larger than the printable area information in the tape width direction.

3. The tape printing apparatus according to claim 1, wherein the character size change process unit refers to the character size type to change, by one stage in each, the character size of the specified line or the character size of the line except for the specified line.

4. The tape printing apparatus according to claim 1, further comprising a display control unit which displays that the character size cannot be changed, when the character size is the maximum size or minimum size stored in the character size type before the character size change process unit changes the character size and, at the same time, when the character size cannot be changed in a large or small way any more.

5. The tape printing apparatus according to claim 1, wherein the character size change instruction operating unit has a first operation unit which provides an instruction to enlarge the character size of the specified line and a second operation unit provides an instruction to reduce the character size of the specified line.

6. A tape printing method including a character size type storage unit which stores a plurality of types of character sizes and a printable area information storage unit which stores printable area information in a width direction of tape in which a character string is printed, the tape printing method comprising the steps of:
determining the character size of each line of an input character string from the character size types using a character size determination unit based on the number of lines of the input character string and the printable area information of the tape;
capturing a change instruction of a user using a character size change instruction operating unit for the character size of a line which is specified by the user in the character size of each line determined by the character size determination unit;
changing the character size of the specified line to a different size in the character size types using a character size change process unit when the character size change instruction operating unit captures the change instruction of the character size; and
printing the input character string on the tape using a tape printing unit with the character size changed by the character size change process unit.
